(19) United States
(12) Patent Application Publication
(10) Pub. No.: US 2014/0325800 A1
(43) Pub. Date: Nov. 6, 2014

(54) SINGLE ROPE TIE DOWN DEVICE

(71) Applicants: James L. Wilson, Little Elm, TX (US); Don Hitt, Rogers, AR (US); Randy Jack, Cherokee Village, AR (US)

(72) Inventors: James L. Wilson, Little Elm, TX (US); Don Hitt, Rogers, AR (US); Randy Jack, Cherokee Village, AR (US)

(21) Appl. No.: 13/853,688

(22) Filed: Mar. 29, 2013

(51) Int. Cl. B62J 7/08

(52) U.S. Cl. CPC B62J 7/08
USPC 24/300

(57) ABSTRACT

A single rope tie down device has a single rope with an internal passageway and two S-hooks. The single rope has a first end and a second end. The internal passageway is proximate to the first end of the rope. The first S-hook is attached to the first end of the single rope. The second S-hook is freely moveable along the single rope between the internal passageway and the second end of the rope. The second end of the rope passes through the eyelet of the first S-hook and then passes through the internal passageway of the single rope forming a closed, adjustable length loop in the single rope. The second S-hook is moveable along the single rope within the loop. The loop can be tightened or loosened to secure the S-hooks to an item below the single rope tie down device to a carrier.

### BACKGROUND OF THE INVENTION

This invention relates generally to a tie down device and, more particularly, this invention is directed to a tie down device that uses a single rope to secure an item to the bed of a truck, to the roof of a car, to a flat bed or to be carried by an individual.

Many individuals choose to move cargo such as construction materials, home furnishings and the like themselves by employing pickup trucks, flatbed trucks, and the like. The individual loads the cargo onto the truck and then secures the cargo so the cargo does not move or fall out of the truck and be damaged.

Pickup trucks are specially designed to carry various cargo loads in their beds. Tie down devices have been invented to help stabilize the cargo loads so that they do not shift and move around during transportation, thereby preventing any potential damage to the load and/or the truck itself.

Pickup trucks will typically have anchor points on the side of the bed of the truck or anchor rings in the bed of the truck.

Many states have implemented laws that require individuals to secure loads while transporting material, equipment, and debris.

Typically, there have been three means to secure an item to a vehicle or to secure an item for carrying by an individual. The first means is a rope, the second means is a bungee cord with J-hooks and the third means is a ratchet and strap. The present application will present a fourth means, a variation of the first means of a rope.

A rope can be used to secure an item to a vehicle or to secure an item for carrying by an individual. The rope is tied to an anchor point or an anchor ring than around or over the item and tied to another anchor point or anchor ring. Ropes can also be tied around a rail.

Rope presents problems when being used as a tie down device.

Many possible uses of a rope tie down device do not have an anchor point to tie to or a rail to tie around, such as the edge of a car roof.

Knots are difficult to tie securely in darkness, cold, ice, snow or rain and difficult to tension. Knots are even more difficult to tie while wearing gloves due to cold or wet conditions and difficult to tension.

Knots are difficult to tie quickly when the cargo needs to be secured and under tension quickly.

Slip knots have the tendency to slip undone with potentially catastrophic results to a cargo which was supposedly secured by a rope. More sophisticated knots are more secure but require knowledge beyond the typical individual trying to tie down an item on a car roof or in a truck bed.

A bungee cord can be used to secure an item to a vehicle or to secure an item for carrying by an individual. The bungee cord typically includes an elastic cord with a pair of J-hooks attached to opposed ends.

One J-hook is secured on one side of the vehicle, the bungee cord is stretched over the item to be secured, and the other J-hook is secured to the opposite side of the vehicle. The stretched bungee cord holds the item in tension to secure it to the bed or roof of a vehicle.

A bungee cord with a J-hook at each end presents its own problems when being used as a tie down device.

A bungee cord will have a fixed length. A bungee cord will have a maximum stretched length before failure of the cord. If the distance the bungee cord has to secure an item is less than the fixed length of the bungee cord, the item cannot be secured by the bungee cord. If the distance the bungee cord has to secure an item is greater than the maximum stretched length of the bungee cord, the item cannot be secured by the bungee cord. A bungee cord with J-hooks only works as a tie down device within a narrow range of length to secure the item.

A bungee cord can only apply one tension level to the item being secured, based on the stretch of the bungee cord. A bungee cord cannot tighten or loosen the amount of tension to secure the item.

A ratchet and strap can be used to secure an item to a vehicle or to secure an item for carrying by an individual.

The ratchet tie down includes an adjustable strap on one side of a ratcheting buckle and a fixed strap on the other side of the ratcheting buckle. Hooks on each strap are attached to anchor points or anchor rings with the item to be secured in between. The ratcheting buckle includes a handle and a bale or spool. The adjustable strap is rolled up around the bale or spool. An individual then applies tension to the straps by ratcheting the handle. This draws the adjustable strap onto the spool and tightens down on the secured item to hold it in place.

A ratchet and strap present their own problems when being used as a tie down devices.

A ratchet and strap tie down device has difficulty in adjusting the length of the strap. This is especially true for those devices incorporating complex and inconvenient ratcheting or cam mechanisms. Most ratchet and strap tie down devices are complicated and expensive to manufacture. Other ratchet and strap tie down devices incorporate sheaves, pins, springs, ratchets, cams, and other small parts that will wear out, potentially fail suddenly and without warning, and not work properly in harsh, muddy, wet, and extremely cold environments.

Both the hook of the adjustable and fixed straps must be connected before ratcheting the handle of the buckle. The weight of the buckle often creates a sag in the tie down that can result in the hooks becoming disconnected from the loops or holes. Additionally, it is not uncommon for the buckle to become positioned (such as between two articles being retained) so that it becomes difficult to operate the ratcheting buckle. Another problem with the ratcheting buckle is that the repeated ratcheting motion required to increase tension is time consuming and difficult. Individuals having limited strength or dexterity find it difficult to use.

Releasing the tension of the ratcheting buckle is often times more difficult than ratcheting the buckle. To release the tension, the spring-pressed ratchet has to be lifted to free the bale. Unfortunately, the tension on the spool and ratcheting teeth is often times greater than the strength of an average person. As a result, often times, an individual has to utilize a tool such as a pliers or screwdriver to release the tension.

There exists a need for an adjustable tie down device that is easy to use, portable, easy to store, and easily accessible for repeated use.

There exists a need for a tie down device to be constructed from substantially lightweight materials, that are inexpensive to manufacture and ship.

This invention relates to a simple and inexpensive device for enabling the tie down of lines, ropes or elastic cables to be quickly and easily attached, tensioned, and reliably fixed in place under tension, while also enabling them to be quickly and easily released.

The purpose of this present invention is to provide a single rope tie down device that requires no knots, has an adjustable length, has an adjustable tension which is easy to use, quick to use and is low cost.

### SUMMARY OF THE INVENTION

This invention discloses a single rope tie down device having a single rope with an internal passageway and two S-hooks. The single rope has a first end and a second end. The single rope has a short first handling section, a short second gripping section and a long third handle section. The internal passageway is in the second section. The rope is typically a braided polypropylene rope.

The first S-hook is attached to the first end of the single rope. The second S-hook is freely moveable along the single rope between the internal passageway and the second end of the rope. The second end of the rope passes through the eyelet of the first S-hook and then passes through the internal passageway of the single rope forming a closed, adjustable length loop in the single rope. The second S-hook is moveable along the single rope within the loop.

The second section of rope will grip the rope in the internal passageway.

The loop can be tightened or loosened to secure the S-hooks to secure an item below the single rope tie down device to a carrier.

The length between the two S-hooks can be expanded to reach opposing points by pulling on opposite sides of the rope within the loop or by holding onto the first handling section of the rope and pulling on the rope within the loop.

The loop is tightened by pulling on the second end of the rope or by pulling on the second end of the rope while holding onto the first handling section of the rope. The length of rope between the S-hooks shortens or tightens to secure the item in position under tension.

The two S-hooks of the single rope tie down device can be attached to opposing anchor points or anchors rings in a truck bed to secure a cargo to the truck bed.

The two S-hooks of the single rope tie down device can be attached to each other or to the loop to secure a bundle of firewood by itself. The second end of the rope will be the handle to carry the bundle.

The single rope tie down device can have multiple S-hooks on the loop.

### BRIEF DESCRIPTION OF THE DRAWINGS

FIG. 1 is a side view of the single rope of the single rope tie down device of the present invention.

FIG. 2 is a cross-sectional side view of the internal passageway within the single rope of the single rope tie down device of the present invention.

FIG. 3 is a front view of the first S hook of the single rope tie down device of the present invention.

FIG. 4 is a front view of the first S hook and first end of the rope of the single rope tie down device of the present invention.

FIG. 5 is a side view of the first S hook and first end of the rope of the single rope tie down device of the present invention.

FIG. 6 is a front view of the second S hook of the single rope tie down device of the present invention.

FIG. 7 is a perspective view of the loop of the single rope tie down device of the present invention according to the present invention.

FIG. 8 is a side view of the single rope tie down device of the present invention securing a cargo in a truck bed by anchor points.

FIG. 9 is a side view of the single rope tie down device of the present invention securing a cargo in a truck bed by anchor rings.

FIG. 10 is a side view of two single rope tie down devices of the present invention in parallel securing a cargo in a truck bed.

FIG. 11 is a top view of two single rope tie down devices of the present invention in criss-cross securing a cargo in a truck bed.

FIG. 12 is a top view of two single rope tie down devices of the present invention along the sides of the cargo securing a cargo in a truck bed.

FIG. 13 is a side view of a single rope tie down device of the present invention. securing an item without a separate carrier by attaching the two S-hooks to each other.

FIG. 14 is a side view of a single rope tie down device of the present invention. securing an item without a separate carrier by attaching a single S-hook to the loop.

FIG. 15 is a side view of a single rope tie down device of the present invention. securing an item without a separate carrier by attaching both S-hooks to the loop.

FIG. 16 is a side view of the single rope tie down device of the present invention with multiple S-hooks on the loop.

### DETAILED DESCRIPTION OF DRAWINGS

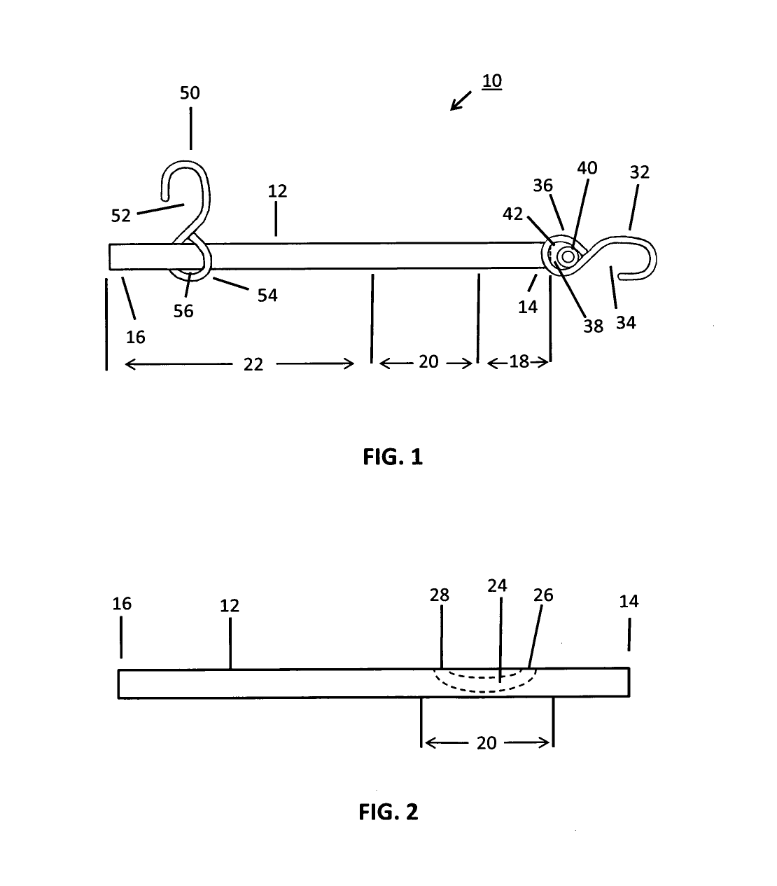

FIG. 1 shows the single rope tie down device 10 of the present invention. The device 10 has a single rope 12 having a first end 14 and a second end 16. The rope has a first short section 18, a second short section 20 and a third long section 22 extending from the first end 14 to the second end 16. The first section 18 of the rope 12 extends from the first end 14 of the rope. The third section 22 of the rope ends at the second end 16 of the rope. The second section 20 of the rope extends from the first section 18 to the third section 22. The first section 18 is the loosening handle section. The second section 20 is the gripping section. The third section 22 is the tightening handle section.

The rope 12 can be any standard length of 3 feet, 4 feet, 6 feet, 10 feet or 12 feet or a nonstandard length if the use of the single rope tie down device 10 requires the nonstandard length. The length of the single rope 12 is not shown to scale in the drawings for ease of understanding the invention.

As seen in FIG. 1 and best seen in the cross-sectional view of FIG. 2, an internal passageway 24 extends from a first external hole 26 in the rope 12 to a second external hole 28 in the rope 12 in the second gripping section 20 of the rope 12. The first external hole 26 is proximate to the first end 14 of the rope 12. The second external hole 28 is nearer to the second end 16 of the rope 12 than to the first external hole 22.

The first handle section 18 of the rope is at least six inches long. Thus, the first external hole 16 of the internal passageway 24 will be at least 6 inches from the first end of the rope. This distance for the first handle section allows for a handhold 30 on the rope in the first section 18 between the first end 14 of the rope 12 and the internal passageway 24.

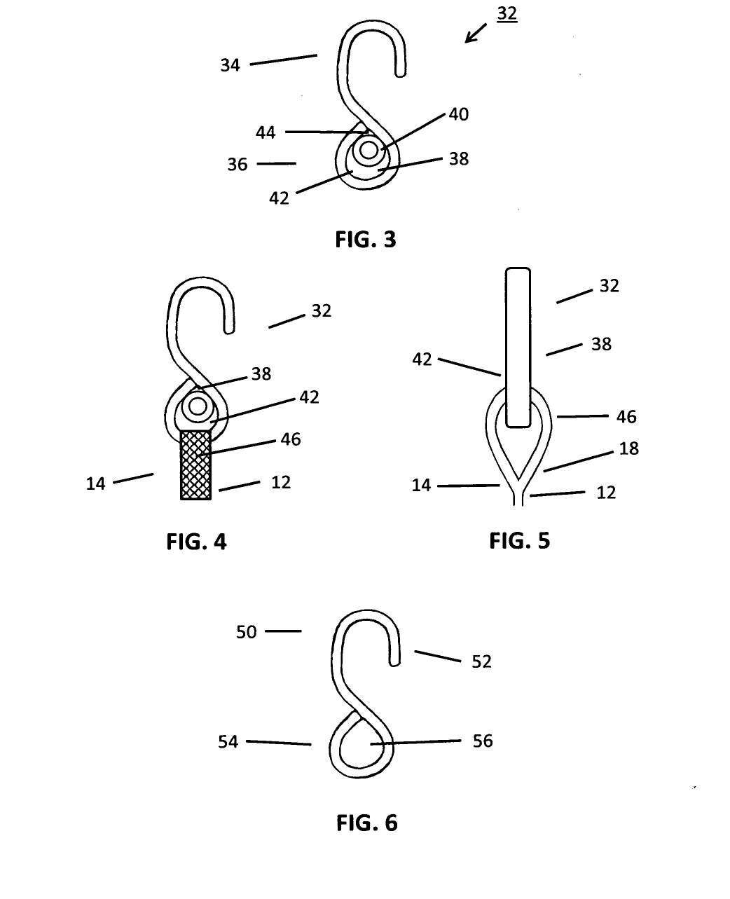

As best seen in FIGS. 1 and 3, a first S-hook 32 has an open first end 34 with a half S or C shape and a closed second end 36 with an opening 38.

An eyelet 40 is positioned within the opening 38 leaving a half moon shaped cavity 42 between the eyelet 40 and the interior end 44 of the opening 38 opposite the first end 34 of the first S-hook 32. The eyelet 40 is approximately circular and the opening 38 is approximately oval. The circular eyelet 40 within the oval opening 38 leaves a half moon shaped cavity 42 between the exterior surface of the eyelet and the interiors surface of the opening.

As seen in FIG. 4 and FIG. 5, a braid 46 of the first end 14 of the single rope 12 is attached through the cavity 42 of the opening 38 in the first S-hook 32. The optimum extension 48 of the braid is 3 inches back into the first section 18 of the single rope 12.

Alternately, the first end 14 of the rope can be attached by being tied through the cavity 42 of the first S-hook 32, or by being braided or spliced by other methods through the cavity 42 of the first S-hook 32.

As seen in FIGS. 1 and 6, a second S-hook 50 has an open first end 52 with a half S or C shape and a closed second end 54 with an opening 56.

The second S-hook 50 is positioned on the single rope 12 in the third tightening handle section 22 of the rope. The rope 12 runs through the opening 56 of the second S-hook 50 so the second S-hook 50 moves freely along the rope 12.

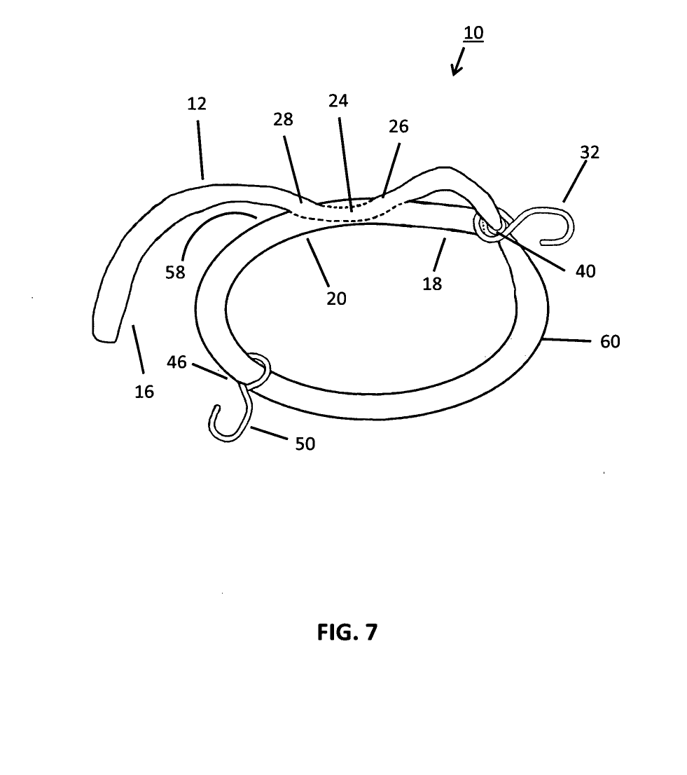

To form the single rope tie down device 10 of the present invention, the second end 16 of the single rope 12 as seen in FIG. 7 passes through the eyelet 40 of the first S-hook 32. The second end 16 of the single rope 12 then passes into the first external hole 26 in the second gripping section 20 of the rope 12, through the internal passageway 24, and out through second external hole 28 in the second gripping section 20 of the rope 12. The holes 26 and 28 of the internal passageway 24 are in the outside surface 58 of the single rope 12.

The single rope 12 passes through the eyelet 40 of the first S-hook 32 and the internal passageway 24 of the first rope to form a closed, adjustable length loop 60 in the single rope 12 of the single rope tie down device 10.

The second gripping section 20 and the internal passageway 24 allow the rope to be fixed in position under tension. The rope within the internal passageway will be a portion of the third section 22 of the rope.

The single rope moves through the eyelet and the internal passageway allowing the loop to expand or contract. The rope 12 in the loop 60 passes through the opening 46 of the second S-hook 50. The second S-hook 50moves freely by sliding along the rope 12 within the loop 60.

The second end 16 of the rope 12 serves as a handle in the third tightening handle section 22.

The second gripping section 20 of the rope functions as an outer shell around a hollow core where a portion of the third section 22 of the rope is positioned within the internal passageway 24. The outer shell, specifically the braid of the rope and the length of the internal passageway, allows the rope to be moved backwards and forwards and positioned with the internal passageway while still securing the rope within the internal passageway in a fixed position at a fixed length. This design allows the loop of the rope to be loosened or tightened but still secure the item in place under tension.

The length of the internal passageway 24 will vary based on the length of the single rope 12. The length of the internal passageway is determined based on the total length of the rope and the braid of the rope. The longer the single rope is then the longer the internal passageway will be. A four foot single rope will have an approximate length of four inches for the internal passageway. A four foot single braided rope will have an approximate length of six cross over braids for the internal passageway. The hollow core or internal passageway of the braided rope will grip or tighten around the third loop section of the rope, when that third section passes through the internal passageway of the second section.

The tie down rope does not grip as well if the internal passageway is short. The tie down rope does not grip as well if the braid is loose. Conversely, if the internal passageway is too long or the braids of the rope are too tight, then the tie down rope binds when pulled through the internal passageway or the rope will ball up at the entry external holes.

The loop of the tie down device can be loosened or tightened to allow the two S-hooks to be secured to opposite points to secure an item in position under tension.

The length between the two S-hooks can be extended to reach the opposing points and the loop loosened by pulling on opposite sides of the rope 12 within the loop 60 or by holding onto the first handling section 18 of the rope and pulling on the rope within the loop.

The length between the two S-hooks can be shortened reach the opposing points and the loop tightened by pulling on the second end 16 of the rope or by pulling on the second end 16 of the rope while holding onto the first handling section 18 of the rope.

The length of rope between the S-hooks shortens or tightens to secure the item in position under tension.

The rope, intertwined thru the internal passageway, applies pressure on each strand of the single rope. The external section or outer shell of the second section of the rope collapses as tension is applied, causing the clamping action in the internal passageway. The more tension applied by pulling the second end of the rope, the more force is placed on the constriction of the passageway, holding tighter on the inner portion of the third section of the rope. As the rope is further tightened, the outer shell compresses onto the inner member and produces more clamping force. The clamping force is then multiplied by the amount of downward pull imposed by the user. This forms a friction clamp on the rope.

The second end of the single rope passes through the eyelet of the first S-hook and then passes through the internal passageway of the single rope. Passing the rope through the eyelet of the first S-hook reduces the slippage of the rope and increases the tension that can be applied to the two S-hooks in securing an cargo, particularly in combination with the subsequent passing the rope through the internal passageway within the single rope.

The single rope of the present invention can be braided rope such as single braid, braid upon braid, hollow braid, diamond braid, solid braid or kernmantle with a hollow core; twisted rope; or plaited rope. The rope must have a hollow core, made in a fashion that includes a braid in the outer shell. The braid then can be of different configurations such as diamond using various numbers of filaments or strands in the braid. To make the hollow core rope, 12 to 16 individual strands or filaments are gathered into groups. The groups, numbering from 6 to 16 are then braided with the braiding machine forming the shell of the rope, which then is hollow. The braided rope is typically polypropylene. The single rope of the present invention can be made from natural fibers such as coir, cotton, hemp, jute, linen, manila, silk, sisal, straw or wool; or from synthetic fibers such as acrylics, aramids, nylon, polyimides, polyesters, polyethylene, or polypropylene; or combinations of different natural fibers; combinations of different synthetic fibers; combinations of different natural fibers and synthetic fibers; or metal. Poly has a slick feel, adding lubricity to allow the rope to glide over or thru the passageway. It also provides UV protection and has a sufficient light weight that it floats.

The single rope tie down device 10 of the present invention secures an item to a carrier.

The item to be secured can be loose, palletized, or containerized. The item is secured to a carrier. The carrier can be a vehicle, a pallet, or another section of the item itself. The carrier can be moving or stationary.

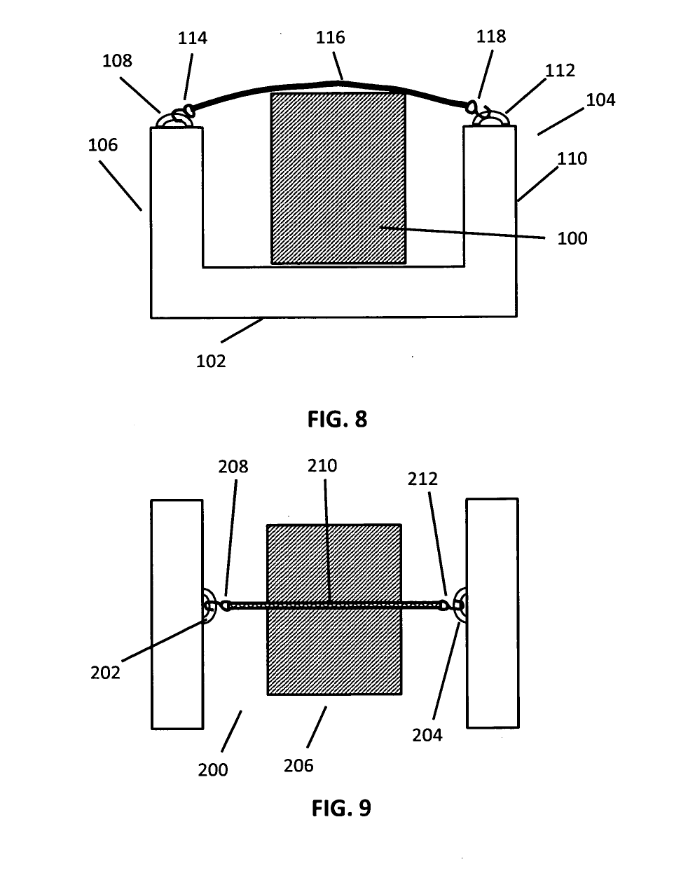

In an illustrative example of FIG. 8, the item to be secured to a carrier is cargo 100 to be tied down to the bed 102 of a truck 104. For ease of understanding the invention, the cab and front of the truck are not shown in the figures.

The first sidewall 106 of the truck bed 102 has a first anchor point 108 at the top of the sidewall 106. The second opposite sidewall 110 of the truck bed 102 has a second anchor point 112 at the top of the sidewall.

In operation, the cargo 100 is positioned in the truck bed 102 between the two anchor points, 108, 112. The first S-hook 114 of the single rope tie down device 116 of the present invention is attached to the first anchor point 108. The tie down device 116 is laid over the cargo 100. The second S-hook 118 of the tie down device 116 is attached to the second anchor point 112. The single rope tie down device is loose and moveable above the cargo.

The length between the two S-hooks can be expanded to reach the opposing anchor points of the truck bed by pulling on opposite sides of the rope within the loop or by holding onto the first section of the rope and pulling on the rope within the loop.

The loop is tightened by pulling on the second end of the rope or pulling on the second end of the rope while holding onto the first section of the rope. The length of rope between the S-hooks shortens or tightens pushing down on the cargo onto the truck bed to secure the cargo in position on the truck bed with no or limited movement of the cargo on the truck bed. The single rope tie down device holds the cargo in tension against the truck bed.

The two S-hooks are secured under tension to hold an cargo to the truck bed and the rope is pulled tight through the internal passageway.

The tie down device is tightened over the top of the cargo until the cargo is held securely under tension to the bed of the truck.

The cargo can be removed or repositioned on the truck bed by pulling on opposite sides of the rope within the loop or by holding onto the first section of the rope and pulling on the rope within the loop to expand the length of the single rope tie down device and allow the cargo to be moveable.

The cargo is transported by the truck. The rope of the tie down device is loosened and the cargo is then removed from the truck bed.

The truck bed 200 has a first anchor ring 202 and a second anchor ring 204 in the truck bed in FIG. 9. The cargo 206 is positioned in the truck bed 200 between the two anchor rings, 202, 204.

The first S-hook 208 of the single rope tie down device 210 of the present invention is attached to the first anchor ring 202. The tie down device is laid over the cargo. The second S-hook 212 of the single rope tie down device is attached to the second anchor ring 204.

The tie down device is tightened over the top of the cargo until the cargo is held securely under tension to the bed of the truck.

The cargo is transported by the truck. The rope of the tie down device is loosened and the cargo is then removed from the truck bed.

Multiple, single rope tie down devices can be used to secure an item.

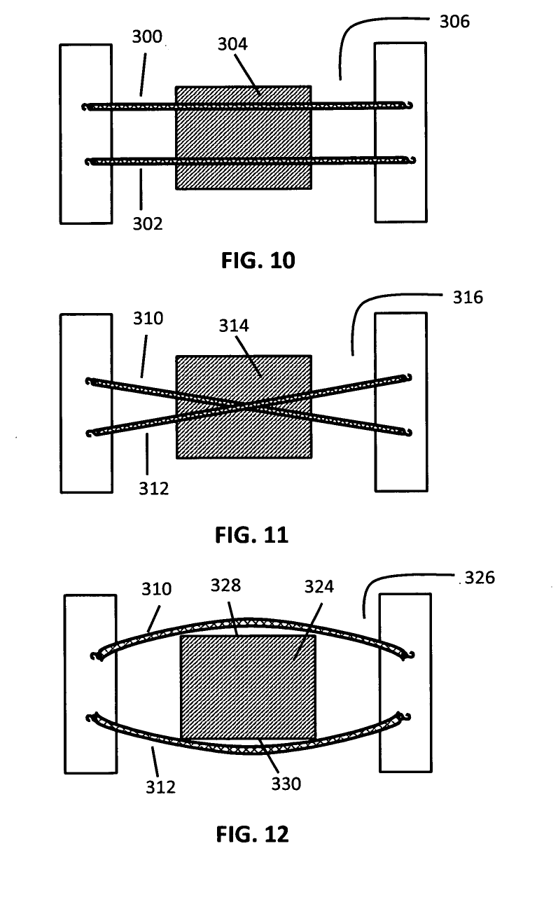

As seen in FIG. 10, two single rope tie down devices 300, 302 are in parallel over the cargo 304 to a truck bed 306.

As seen in FIG. 11, two single rope tie down devices 310, 312 criss-cross over the cargo 314 to a truck bed 316.

As seen in FIG. 12, two single rope tie down devices 320, 322 secure an item, specifically a cargo 324 to a truck bed 326, with one tie down device 320 securing the front side 328 of the cargo 324 and the other tie down device 322 securing the back side 330 of the cargo 324.

The single rope tie down device of the present invention can be used to secure an item for carrying without a separate carrier.

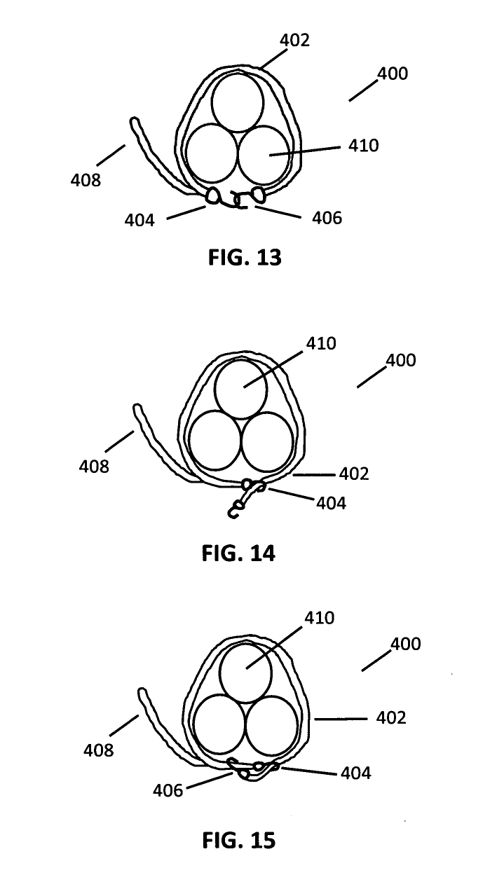

The single rope tie down device 400 of FIG. 13 shows the loop 402, the first S-hook 404, the second S-hook 406, and the second end handle 408. Other elements present in the single rope tie down device are not shown for ease of understanding this embodiment.

The tie down device is used to secure an item, a bundle 410 of firewood in this illustrative example.

The tie down device 400 is wrapped around the bundle 410. The first S-hook is attached to the second S-hook. The second end handle is pulled back to tighten the loop around the bundle to secure the bundle of firewood.

The bundle can then be carried by the second end handle or other means now that the bundle is secured by the tie down device.

As show in FIG. 14, a single S-hook 404 (the first S-hook in this example) can be attached to the loop 402 to secure the bundle 410. Alternately, the second S-hook can be the single S-hook attached to the loop to secure the bundle.

As best seen in FIG. 15, both S-hooks 404, 406 can be attached to the loop 402 to secure the bundle 410.

The single rope tie down device of the present invention can have multiple S-hooks on the loop.

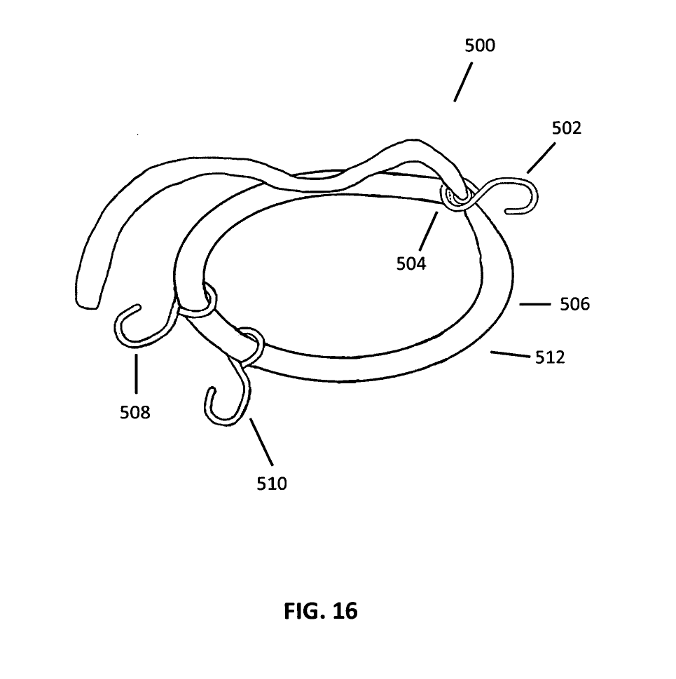

Another alternate single rope tie down device 500 of the present invention in FIG. 16 has a first fixed S-hook 502 attached to the first end 504 of the rope 506 and two other S-hooks 508, 510 freely moveable along the loop 512. Single rope tie down device 500 in FIG. 6 has all the elements and works the same way as single rope tie down device 10 with the addition of a second S-hook inside the loop.

If there is one fixed S-hook and one moveable S-hook, then the two S-hooks should be 180 degrees opposite each other. If there is one fixed S-hook and two moveable S-hooks, then (a) one of the moveable S-hooks can be directly opposite the fixed S-hook or (b) the fixed S-hook and the two moveable S-hooks will form a triangle with angles totaling 180 degrees to maintain tension on all three S-hooks.

A three S-hook single rope tie down device allows for 3 point restraint of the item to be secured. A four S-hook single rope tie down device allows for 4 point restraint of the item to be secured.

While the invention has been described with the inclusion of specific embodiments and examples, it is evident to those skilled in the art that many alternatives, modifications and variations will be evident in light of the foregoing descriptions. Accordingly, the invention is intended to embrace all such alternatives, modifications and variations that fall within the spirit and scope of the appended claims.

1. A single rope tie down device comprises
a single rope having a first end and a second end;
an internal passageway in said single rope having a first hole and a second hole, said first hole being proximate to said first end of said single rope;
a first S-hook having a first end and a second end, said first end of said first S-hook having a C-shape, said second end of said first S-hook having a closed eyelet and said second end of said first S-hook having an opening with an eyelet and a cavity, said first end of said single rope being secured through said cavity of said opening of said second end of said first S-hook;
a second S-hook having a first end and a second end, said first end of said first S-hook having a C-shape, said second end of said second S-hook having a closed end with an opening, said closed opening of said second S-hook being moveable along said single rope between said internal passageway in said single rope and said second end of said single rope;
said second end of said single rope passing through said eyelet of said first S-hook, then passing through said first hole of said internal passageway, through said internal passageway, and out through said second hole of said internal passageway in said single rope forming a closed, adjustable length loop in said single rope, said second S-hook being moveable along said single rope within said loop; and
wherein said loop can be tightened or loosened to secure said first S-hook and said second S-hook to secure an item below said single rope tie down device to a carrier.

2. The single rope tie down device of claim 1 wherein said single rope has a first section, a second section and a third section extending from said first end of said single rope to said second end of said single rope, wherein said internal passageway is in said second section of said single rope and wherein said third section of said single rope forms said loop, extends through said internal passageway and forms a handle after said internal passageway.

3. The single rope tie down device of claim 2 wherein said second section to said single rope applies pressure to said third section of said single rope within said internal passageway to grip said third section of said single rope within said internal passageway.

4. The single rope tie down device of claim 3 wherein said loop can be tightened by pulling on said second end of said rope or by holding said first section of said single rope and pulling on said second end of said rope;
and wherein said loop can be loosened by pulling on opposite sides of said single rope in said loop or by holding said first section of said single rope and pulling on said single rope in said loop.

5. The single rope tie down device of claim 1 wherein said single rope is a braided rope.

6. The single rope tie down device of claim 1 wherein said single rope is made of polypropylene.

7. The single rope tie down device of claim 1 wherein said single rope is a braided polypropylene rope.
